(19) United States
(12) Patent Application Publication
(10) Pub. No.: US 2024/0117931 A1
(43) Pub. Date: Apr. 11, 2024

(54) PRESSURIZED GAS CONTAINMENT LINER, PRESSURIZED GAS TANK AND METHOD FOR MANUFACTURING AN ASSOCIATED PRESSURIZED GAS CONTAINMENT LINER

(71) Applicant: FAURECIA SYSTEMES D'ECHAPPEMENT, Nanterre (FR)

(72) Inventors: Christophe BAVEREL, AUDINCOURT (FR); Dorian HERNANDEZ, JONCHEREY (FR); David FARALDI, MONTBELIARD (FR); Marc MORET, LA CHAPELLE SUR ERDRE (FR); Thomas BRANGER, MONTAIGU (FR)

(21) Appl. No.: 18/375,623

(22) Filed: Oct. 2, 2023

(30) Foreign Application Priority Data
Oct. 5, 2022 (FR) 22 10191

(51) Int. Cl. F17C 1/08

(52) U.S. Cl. CPC F17C 1/08; F17C 2201/0157; F17C 2203/012; F17C 2203/013; F17C 2203/0604; F17C 2209/221

(57) ABSTRACT

A pressurized gas containment liner includes a first part comprising a first shell, a second part comprising a second shell, and at least one intermediate part, arranged between the first part and the second part, in an assembly direction. The intermediate part is rigidly connected to the first and second parts. The first part, the second part, and the at least one intermediate part together delimit an interior volume. The or at least one of the intermediate parts comprises an intermediate shell and at least one pillar elongated in an elongation direction and connecting two opposite portions of the intermediate shell, and passing through the interior volume perpendicular to the assembly direction. The pillar and the intermediate shell are integral.

### CROSS-REFERENCE TO RELATED APPLICATION

This application is a U.S. non-provisional application claiming the benefit of French Application No. 22 10191, filed on Oct. 5, 2022, which is incorporated herein by reference in its entirety.

### TECHNICAL FIELD

The present disclosure relates to a pressurized gas containment liner. The disclosure relates to a pressurized gas tank comprising such a liner as well as a method for manufacturing such a liner.

### BACKGROUND

In the field of transport means, and in particular in automotive transport, it may prove important to contain pressurized gas. This proves all the more true with the growth of vehicles provided with fuel cells, for which dihydrogen intended to supply a fuel cell must be stored in the vehicle.

It is known to use cylindrical tanks for the containment of pressurized gas in vehicles. Such tanks are generally provided with a cylindrical compression liner, arranged inside a body of the tank, and aiming to ensure the containment of the pressurized gas within the tank.

Such liners, and more generally such tanks, however, are not entirely satisfactory due to their shape which is sometimes unsuitable for the layout of a vehicle.

It has therefore been proposed to use non-cylindrical tanks, for example prismatic tanks. Such tanks generally have the shape of a flattened prism, making it possible to improve the integration of the tank in the vehicle.

However, such tanks are not entirely satisfactory. Specifically, it has been shown that due to their non-cylindrical shape, the tanks are less robust. It has then been necessary to reinforce the tanks locally in order to improve their robustness, and to adapt the liners to such reinforcements. However, the manufacture of such liners has proven complex.

Furthermore, in order to ensure good integration of a liner in a vehicle, it is generally necessary to design and manufacture parts for the liner being specific to the vehicle. This may prove particularly expensive.

Thus, one of the aims of the disclosure is to propose a gas containment liner allowing easier integration into a vehicle while making it possible to obtain a robust tank that is not very complex to manufacture. Another aim of the disclosure is to propose such a liner that is versatile and that can be adapted to different types of vehicles at lower cost.

### SUMMARY

To this end, the disclosure relates to a pressurized gas containment liner, comprising:
a first part, comprising a first shell,
a second part, comprising a second shell,
at least one intermediate part, arranged between the first and the second part, in an assembly direction, the intermediate part(s) being rigidly connected to the first and second parts,
the first part, the second part and the at least one intermediate part together delimiting an interior volume,
the or at least one of the intermediate part(s) comprising:
an intermediate shell, and
at least one pillar elongated in an elongation direction, connecting two opposite portions of the intermediate shell and passing through the interior volume perpendicular to the assembly direction,
the pillar and the intermediate shell being integral.

Such a liner, by using an intermediate part comprising a pillar, makes it possible to obtain a liner that can accommodate reinforcing elements of a tank. Furthermore, since the pillar is integral with the intermediate shell, the mere assembly of the intermediate part to the first and second parts makes it possible to obtain such a liner capable of receiving at least one reinforcement. Finally, since a variable number of intermediate parts can be assembled to the first and second parts, it is particularly easy to adapt the liner to the vehicle on which the liner is intended to be used, simply by modifying the number of intermediate parts rigidly connected between the first and second parts.

According to other advantageous aspects of the disclosure, the pressurized gas containment liner comprises one or more of the following features, taken alone or in any technically feasible combination:
the pressurized gas containment liner comprises a plurality of intermediate parts, adjacent in the assembly direction;
the at least one intermediate part comprises a plurality of pillars, the plurality of pillars being aligned in a direction perpendicular to the assembly direction and to the elongation direction of said pillars;
the at least one pillar is hollow, the pillar comprising a pillar wall, connected to the intermediate shell and delimiting a pillar cavity, the pillar and the intermediate shell delimiting two openings so that the pillar cavity opens on both sides of the intermediate part;
the pressurized gas containment liner is such that:
the first part comprises at least a first reinforcing rib rigidly connected to the first shell, said first reinforcing rib comprising a lumen extending parallel to the elongation direction and opening on both sides of the first part, and/or
the first part comprises at least a second reinforcing rib rigidly connected to the second shell, said second reinforcing rib comprising a lumen extending parallel to the elongation direction and opening on both sides of the second part;
the first part, the at least one intermediate part and the second part, are alternately in the assembly direction, formed of a material configured to be transparent to laser radiation and made of a material configured to absorb the laser radiation,
the first part, the at least one intermediate part and the second part, being rigidly connected to each other in the assembly direction by laser welding;
the first part, the at least one intermediate part and the second part, are rigidly connected together in the assembly direction by butt welding, a resistive sheet being arranged between welded adjacent edges of the first part, the at least one intermediate part or the second part; and
the welded adjacent edges delimit between them an oblique butt welding plane, extending obliquely relative to the assembly direction.

The disclosure further relates to a tank comprising a pressurized gas containment liner as mentioned above, and a tank body arranged around the pressurized gas containment liner, an internal face of the tank body being affixed to an external face of the liner.

The disclosure further relates to a method for manufacturing a pressurized gas containment liner as mentioned above, comprising the following steps:
providing a first part, a second part, and at least an intermediate part of the pressurized gas containment liner;
rigidly connecting the intermediate part(s) to the first and second parts, the intermediate part(s) being arranged between the first part and the second part in the assembly direction.

### BRIEF DESCRIPTION OF THE DRAWINGS

The disclosure will be better understood on reading the following description, given solely by way of non-limiting example, and referring to the drawings in which:

FIG. 1 is a perspective view of a tank comprising a liner according to the disclosure, during the manufacturing of the tank;

FIG. 2 is a cross-sectional view of the tank of FIG. 1 along a cutting plane I-I′, the manufacturing of the tank being completed;

FIG. 3 is a perspective view of the tank of FIG. 1 in its entirety; and

FIG. 4 is a cross-sectional view along the plane I-I′ of a detail of the rigid connection between two parts of a liner according to an alternative embodiment to the embodiment shown in FIGS. 1 to 3.

### DETAILED DESCRIPTION

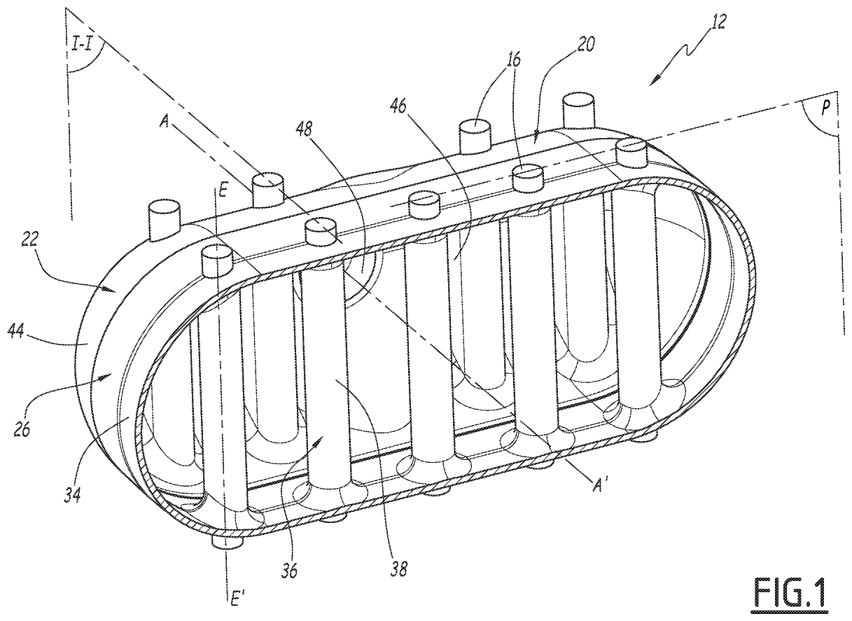

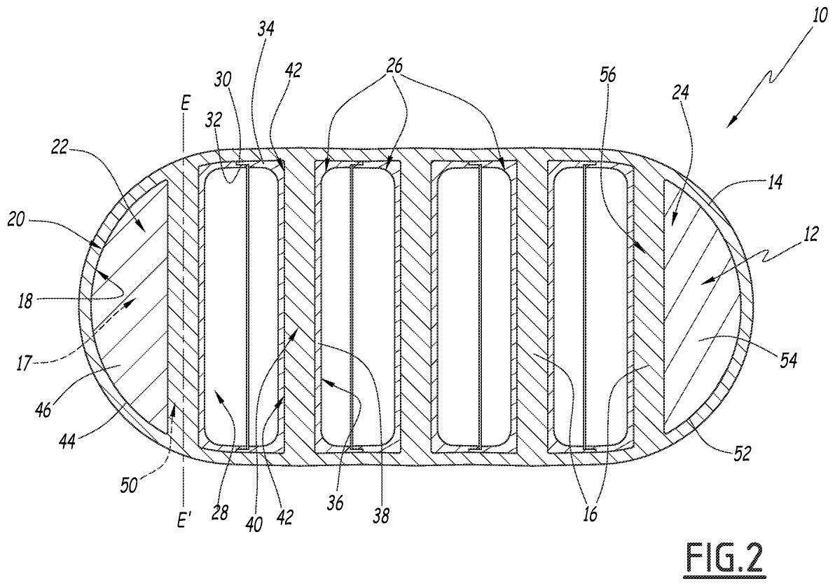

With reference to FIGS. 1 to 3, a pressurized gas tank 10 comprises a pressurized gas containment liner 12. As can be seen in FIG. 2, the tank 10 further comprises a tank body 14 as well as at least one tank column 16.

The pressurized gas tank 10 is configured to contain a pressurized gas such as, for example, a reducing fuel gas and such as in particular pressurized hydrogen. The tank of pressurized gas 10 is, for example, configured to contain a gas at a pressure greater than 200 bar and for example a gas at a pressure of 350 bar or a gas at a pressure of 700 bar. The pressurized gas tank 10 is further, for example, configured to contain a liquid, such as a liquid phase of the pressurized gas contained in the tank 10, for example.

The tank of pressurized gas 10 is, for example, intended to be installed in a vehicle, for example a motor vehicle. The pressurized gas tank 10 is, for example, configured to supply fuel to a fuel cell of the vehicle (not shown).

The tank body 14, for example, forms a body volume 17 wherein the liner 12 is housed. The tank body 14 comprises, for example, an inner face 18 defining the body volume 17. The tank body 14 is, for example, produced around the liner 12 so that the liner 12 is arranged in the tank body 14, the internal face 18 being, for example, affixed to an external face 20 of the liner.

The tank body 14 is, for example, made from composite. The composite from which the tank body 14 is made comprises, for example, a resin such as: an epoxy resin, or a resin made from at least one thermoplastic polymer selected from the group consisting of polyolefins, in particular polypropylene, polyamides, in particular aliphatic polyamides, such as polycaprolactam PA 6, polyhexamethylene adipamide PA 6.6, polycarbonates, PAEK (polyaryletherketone), including PEEK (polyetheretherketone) and PEKK (polyetherketoneketone), acrylic-based materials such as PMMA (including the resin known as ELIUM), PEI (Polyetherimide also known as ULTEM), PPS (Polyphenylene Sulfide), ABS (Acrylonitrile Butadiene Styrene), PLA (Polylactic Acid), TPU (Thermoplastic Polyurethane) and PET (Polyethylene), and mixtures thereof.

The composite from which the tank body 14 is made comprises for example a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers.

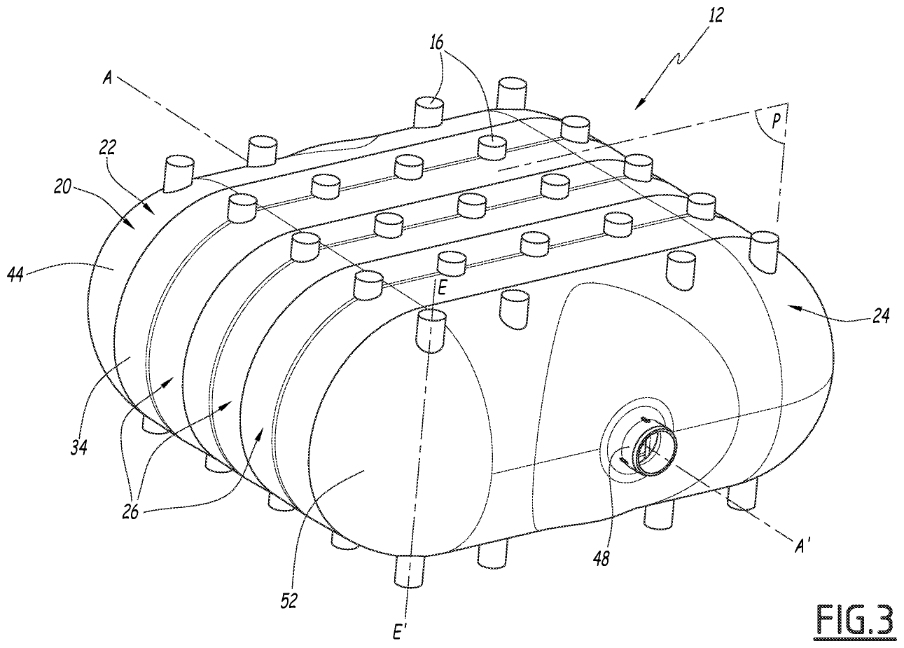

As can be seen in FIG. 2, each tank column 16 extends into the body volume 17 and connects, for example, portions of the inner face 18 of the tank body 14 opposite to each other relative to the body volume 17. In FIGS. 1 and 3, the columns 16 are shown during their installation and are at that point not yet rigidly connected to the tank body 14, the tank body 14 being in particular not formed.

Each tank column 16 is, for example, welded to the tank body 14 at each of the ends of the column 16 and/or made so as to form a single piece with the tank body 14.

Each tank column 16 is for example made from composite. The composite from which each tank column 16 is made comprises, for example, a resin such as: an epoxy resin, or a resin made from at least one thermoplastic polymer selected from the group consisting of polyolefins, in particular polypropylene, polyamides, in particular aliphatic polyamides, such as polycaprolactam PA 6, polyhexamethylene adipamide PA 6.6, polycarbonates, PAEK (polyaryletherketone), including PEEK (polyetheretherketone) and PEKK (polyetherketoneketone), acrylic-based materials such as PMMA (including the resin known as ELIUM), PEI (Polyetherimide also known as ULTEM), PPS (Polyphenylene Sulfide), ABS (Acrylonitrile Butadiene Styrene), PLA (Polylactic Acid), TPU (Thermoplastic Polyurethane) and PET (Polyethylene), and mixtures thereof. The composite from which the tank body 14 is made comprises for example a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers. The composite from which each tank column 16 is made comprises for example a reinforcement made of: fibers selected from the group consisting of carbon fibers, Kevlar fibers, glass fibers, ceramic fibers, fibers of polymeric material, for example thermoplastic, in particular aramid or polyester fibers, fibers of plant origin, in particular flax fibers, metal fibers, the fibers preferably being carbon fibers, or a mixture of such fibers.

In a particular embodiment, the material of the tank columns 16 is the same as the material of the tank body 14.

In a variant not shown, the columns 16 are, for example, hollow.

As seen above, the liner 12 is, for example, arranged in the body volume 17.

The liner 12 is configured to ensure that the tank 10 is leaktight to the pressurized gas while the tank body 14 is configured to ensure that the pressurized gas is pressure-resistant.

As shown in FIG. 3, the liner 12 comprises a first part 22, a second part 24, and at least one intermediate part 26.

The first part 22, the second part 24, and the at least one intermediate part 26 are, for example, made of a thermoplastic material chosen from the list consisting of ABS (Acrylonitrile butadiene styrene), PA (polyamide), PE (polyethylene), PC (polycarbonate), PP (polypropene), PMMA (polymethyl methacrylate), PS (Expanded Polystyrene), PBT (butylene terephthalate). The material of the first part 22, the second part 24, and the at least one intermediate part 26 is for example more particularly chosen from the list consisting of: PA6 (Polycaprolactam), PA11 (polyundecanamide) or PA12 (Nylon 12).

As will be described in more detail below, the thermoplastic material chosen to produce the first part 22, the second part 24, or the at least one intermediate part 26 may comprise an additive.

The liner 12, for example, comprises a plurality, and for example, between one and five intermediate parts. In the embodiment of FIG. 3, the liner comprises three intermediate parts 26.

As shown in FIG. 3, the at least one intermediate part 26 is arranged between the first 22 and the second 24 parts in an assembly direction A-A′. The intermediate part(s) 26 are rigidly connected to the first 24 and second 26 parts. As shown in FIG. 1, when the liner 12 comprises a plurality of intermediate parts 26, the intermediate parts 26 are adjacent in the assembly direction A-A′. One of the intermediate parts 26 is, for example, rigidly connected to the first part 22, another of the intermediate parts 26 is rigidly connected to the second part 24, the other optional intermediate parts 26 each being rigidly connected to intermediate parts 26 being adjacent thereto.

The first part 22, the second part 24 and the at least one intermediate part 26 together delimit an interior volume 28. The interior volume 28 thus delimited is configured to be occupied by the pressurized gas.

The first part 22, the second part 24 and the at least one intermediate part 26 are, for example, alternately along the assembly direction A-A′, made of a material configured to be transparent to laser radiation and made of a material configured to absorb laser radiation. Thus, one of two parts 22, 24, 26 of the adjacent liner 10 is made of a material configured to be transparent to laser radiation, the other of the two parts 22, 24, 26 of the adjacent liner 10 being made of a material configured to absorb laser radiation.

In the example of FIG. 3, the first part 22 and the second part 24 are made of a material configured to absorb laser radiation. The intermediate parts 26 rigidly connected to these first 22 and second parts 24 are then made of a material configured to be transparent to laser radiation, the intermediate part 26 rigidly connected to said intermediate parts 26 then being made of a material configured to absorb laser radiation.

The first part 22, the at least one intermediate part 26 and the second part 24, are then for example, rigidly connected together in the assembly direction A-A′ by laser welding.

As shown in FIG. 2, a part 22, 24, 26, made of a material configured to be transparent to laser radiation comprises an overlapping portion 30 covering an overlapped portion 32 of the part 22, 24, 26 being adjacent to it and being made of a material configured to absorb laser radiation. The first part 22, the at least one intermediate part 26 and the second part 24 are then secured by laser welding between the overlapping portion 30 and the overlapped portion 32 of adjacent parts 22, 24, 26.

The material configured to be transparent to laser radiation is, for example, made of one of the thermoplastic materials presented above, said thermoplastic material being free of light absorption additive.

The material configured to absorb laser radiation is, for example, made from one of the thermoplastic materials presented above, said thermoplastic material comprising a light absorption additive, such as carbon for example.

In a particular embodiment, the material configured to be transparent to laser radiation and the material configured to absorb laser radiation are made from the same thermoplastic material, the difference between these materials being that the material configured to absorb laser radiation is treated using a light absorption additive while the material configured to be transparent to laser radiation is not treated using such an additive.

As can be seen in FIG. 1, the at least one intermediate part 26 comprises an intermediate shell 34 and at least one pillar 36 elongated along an elongation direction E-E′. The at least one intermediate part 26 comprises, for example, between two and eight pillars.

In the embodiment shown in FIGS. 1 to 3, the intermediate part 26 comprises a plurality of pillars 36 and in particular five pillars. The plurality of pillars 36 is, for example, aligned in a direction perpendicular to the assembly direction A-A′ and to the elongation direction E-E′ of said pillars.

The intermediate shell 34 is, for example, of constant profile along the assembly direction A-A′. In the example of FIG. 1, the intermediate shell with an oblong profile according to a plane normal to the assembly direction A-A′, this profile being constant along the assembly direction A-A′.

The at least one elongated pillar connects two opposite portions of the intermediate shell 34 and passes through the interior volume 28 perpendicular to the assembly direction A-A′. The pillar 36 and the intermediate shell 34 are in particular integral.

The interior volume 28 then extends inside the intermediate shell 34, around the or each pillar 36.

As can be seen in FIG. 1, the at least one elongate pillar 36 extends for example along a median plane P of the intermediate part 26, the plane P being orthogonal to the assembly direction A-A′.

As can be seen in FIG. 2, the pillar 36 is hollow. The pillar 36 in particular comprises a pillar wall 38, connected to the intermediate shell 34, and delimiting a pillar cavity 40. A thickness of the pillar wall 38 is, for example, substantially equal to a thickness of the intermediate shell 34.

The pillar 36 and the intermediate shell 34 delimit, for each pillar 36, two openings 42 of the cavity of said pillar 36, so that the pillar cavity 40 opens on both sides of the intermediate part 26.

As shown in FIG. 2, a tank column 16 is housed in the cavity 40 of each pillar 36, the tank column 16 protruding from the cavity 40 on both sides of the intermediate part 26, through the two openings 42 (the columns 16 are shown during their installation in FIGS. 1 and 3).

The first part 22 comprises a first shell 44. The first part 22 further comprises, for example, at least a first reinforcing rib 46.

The first part 22 and the intermediate part 26 adjacent to the first part 22 are, for example, rigidly connected to each other by rigidly connecting the first shell 44 to the intermediate shell 34 of the adjacent intermediate part 26.

As shown in FIG. 1, at least one port 48 of the tank 10 is, for example, housed in the first part 22 to allow access to the interior volume 28, for example for filling the interior volume 28 with pressurized gas and/or emptying it of same.

Each first reinforcing rib 46 is rigidly connected to the first shell 44. In particular, each first reinforcing rib 46 and the first shell 44 are, for example, integral.

As shown in FIG. 2, the reinforcing rib 46 comprises a lumen 50 extending parallel to the elongation direction E-E′. In other words, the lumen 50 extends parallel to the at least one pillar of the at least one intermediate part 26. The lumen 50, for example, opens on both sides of the first part 22.

A tank column 16 is, for example, housed in the lumen 50 of each first reinforcing rib 46 and protrudes on both sides of the lumen 50 while being rigidly connected to the tank body 14.

The second part 24 comprises a second shell 52. The second part 24 further comprises, for example, at least a second reinforcing rib 54.

The second part 24 and the intermediate part 26 adjacent to the second part 24 are, for example, rigidly connected to each other by rigidly connecting the second shell 52 to the intermediate shell 34 of the adjacent intermediate part 26.

As shown in FIG. 2, at least one port 48 of the tank 10 is, for example, housed in the second part 24 to allow access to the interior volume 28, for example for filling the interior volume 28 with pressurized gas and/or emptying it of same.

Each second reinforcing rib 54 is rigidly connected to the second shell 52. In particular, each second reinforcing rib 54 and the second shell 52 are, for example, integral.

As shown in FIG. 2, the second reinforcing rib 54 comprises a lumen 56 extending parallel to the elongation direction E-E′. In other words, the lumen 56 extends parallel to the at least one pillar of the at least one intermediate part 26. The lumen 56, for example, opens on both sides of the second part 24.

A tank column 16 is, for example, housed in the lumen 54 of each second reinforcing rib 54 and protrudes on both sides of the lumen 50 while being rigidly connected to the tank body 14.

A second embodiment of a liner 12 for compressing pressurized gas will now be presented. According to this second embodiment, the liner 12 differs from the embodiment presented above. Similar elements bear the same references.

In this second embodiment, the first part 22, the at least one intermediate part 26, and the second part 24, are not assembled by laser welding but are assembled in the assembly direction A-A′ by butt welding.

To this end, the parts 22, 24, 26 are not necessarily alternately made of a material configured to be transparent to laser radiation and made of a material configured to absorb the laser radiation. The parts 22, 24, 26 then do not necessarily comprise an overlapping portion 30 and/or overlapped portion 32.

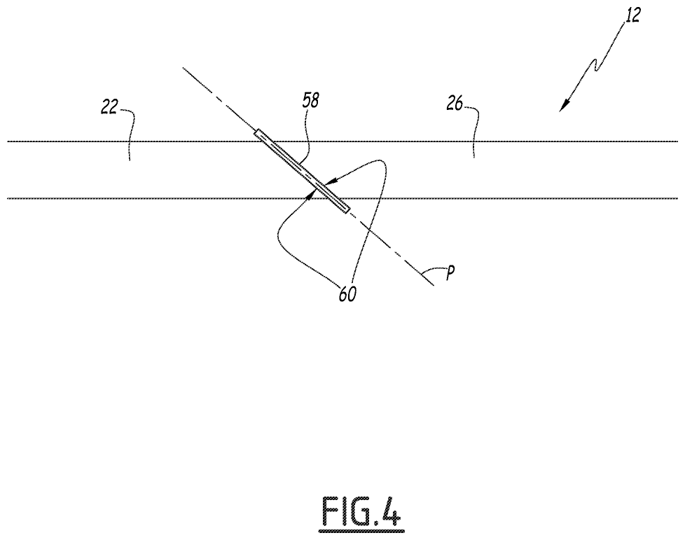

According to this embodiment, and as shown in FIG. 4, a resistive sheet 58 is arranged between welded adjacent edges 60 of the first part 22, of the at least one intermediate part 26 or of the second part 24. The welding of two parts 22, 24, 26 is then carried out via the resistive sheet and results in particular from local melting of the adjacent edges 60 on both sides of the resistive sheet 58. FIG. 4 shows the welding between adjacent edges 60 of the first part 22 and intermediate part 26.

The resistive sheet 58 is configured to be heated by the Joule effect and is, for example, made of carbon.

The adjacent edges 60 delimit between them a butt welding plane S. As shown in FIG. 4, the butt welding plane S is, for example, oblique relative to the assembly direction, that is to say that the butt welding plane S is not orthogonal to the assembly direction A-A′. The welding plane, for example, forms an angle between 0° and 80° relative to the assembly direction A-A′, and in particular between 30° and 60°.

A third embodiment of a liner 12 for compressing pressurized gas will now be presented. According to this third embodiment, the liner 12 differs from the embodiments presented above as described below. Similar elements bear the same references.

In this third embodiment, the first part 22, the at least one intermediate part 26 and the second part 24, are not assembled by laser welding nor by butt welding, but are assembled in the assembly direction A-A′ by hot gas welding.

To this end, the parts 22, 24, 26 are not necessarily alternately made of a material configured to be transparent to laser radiation and made of a material configured to absorb the laser radiation. No resistive sheet is further arranged between adjacent edges of the portions 22, 24, 26. Two adjacent parts may however comprise an overlapping portion 30 respectively an overlapped portion 32, as in the first embodiment. Said adjacent parts are for example rigidly connected to each other by a weld of the overlapping portions 30 and covered 32 resulting from heating using a hot gas, such as hot air.

A method for manufacturing a pressurized gas containment liner 12 as described above will now be presented.

During a first step, a first part 22, a second part 24, and at least one intermediate part 26 of the liner 12 are provided.

During a second step, the intermediate part(s) 26 are rigidly connected to the first 22 and second 24 parts, the intermediate part(s) 26 being arranged between the first part 22 and the second part 24 in the assembly direction A-A′. When the liner 12 comprises a plurality of intermediate parts 26, the adjacent intermediate parts 26 are furthermore rigidly connected to each other.

According to the first embodiment, presented above, the first part 22, second part 24 and intermediate part 26 are joined together by laser welding. A laser beam is pointed on the overlapped portion 30 through the overlapping portion 32. This generates a heating of said portions 30, 32, resulting in a welding of the parts comprising said portions 30, 32.

According to the second embodiment, the first part 22, second part 24 and intermediate part 26 are joined together by butt welding. The adjacent edges 60 of two parts are affixed on both sides of the resistive sheet 58. A current is then generated through the resistive sheet 58 for its heating by the Joule effect. The adjacent edges 60 are thus heated, resulting in the adjacent edges 60 being welded to the resistive sheet 58.

According to the third embodiment, presented above, the first part 22, second part 24, and intermediate part 26 are joined together by hot gas welding.

The heating of adjacent parts for their local melting and for the resulting weld is then carried out by way of a hot gas jet.

It will be understood that the various welding modes presented in the three above embodiments can be combined and are for example interchangeable. For example, the first part 22 is rigidly connected to one of the intermediate parts 26 by laser welding, the second part 24 is rigidly connected to another of the intermediate parts 26 by laser welding, the intermediate parts 26 being welded together by butt welding.

The disclosure has been shown and described in detail in the drawings and the preceding description. This must be considered as illustrative and given by way of example and not as limiting the disclosure to this only description. Many alternative embodiments are possible.

1. A pressurized gas containment liner, comprising:
a first part, comprising a first shell;
a second part, comprising a second shell;
at least one intermediate part, arranged between the first part and the second part, in an assembly direction, the at least one intermediate part being rigidly connected to the first part and the second part;
the first part, the second part, and the at least one intermediate part together delimit an interior volume;
the least one intermediate part or at least one of the intermediate part(s) comprising:
an intermediate shell, and
at least one pillar elongated in an elongation direction, connecting two opposite portions of the intermediate shell and passing through the interior volume perpendicular to the assembly direction,
the at least one pillar and the intermediate shell being integral,
the at least one intermediate part comprises a plurality of intermediate parts, and
wherein the pressurized gas containment liner comprises the plurality of intermediate parts, adjacent in the assembly direction.

2. The pressurized gas containment liner according to claim 1, wherein the at least one pillar comprises a plurality of pillars, and wherein the at least one intermediate part comprises the plurality of pillars, the plurality of pillars being aligned in a direction perpendicular to the assembly direction and to the elongation direction of the plurality of pillars.

3. The pressurized gas containment liner according to claim 1, wherein the at least one pillar is hollow, the at least one pillar comprising a pillar wall, connected to the intermediate shell and delimiting a pillar cavity, the at least one pillar and the intermediate shell delimiting two openings such that the pillar cavity opens on both sides of the at least one intermediate part.

4. The pressurized gas containment liner according to claim 1, wherein:
the first part comprises at least a first reinforcing rib rigidly connected to the first shell, said first reinforcing rib comprising a lumen extending parallel to the elongation direction and opening on both sides of the first part, and/or
the second part comprises at least a second reinforcing rib rigidly connected to the second shell, said second reinforcing rib comprising a lumen extending parallel to the elongation direction and opening on both sides of the second part.

5. The pressurized gas containment liner according to claim 1, wherein the first part, the at least one intermediate part, and the second part, are alternately in the assembly direction, formed of a material configured to be transparent to laser radiation and made of a material configured to absorb the laser radiation, and
the first part, the at least one intermediate part, and the second part, being rigidly connected to each other in the assembly direction by laser welding.

6. The pressurized gas containment liner according to claim 1, wherein the first part, the at least one intermediate part, and the second part, are rigidly connected together in the assembly direction by butt welding, a resistive sheet being arranged between welded adjacent edges of the first part, of the at least one intermediate part, or of the second part.

7. The pressurized gas containment liner according to claim 6, wherein the welded adjacent edges delimit therebetween an oblique butt welding plane extending obliquely relative to the assembly direction.

8. A pressurized gas tank comprising the pressurized gas containment liner according to claim 1, and a tank body arranged around the pressurized gas containment liner, an inner face of the tank body being affixed to an outer face of the pressurized gas containment liner.

9. A method for manufacturing a pressurized gas containment liner, comprising the following steps:
providing a first part, a second part, and at least one intermediate part of the pressurized gas containment liner;
rigidly connecting the at least one intermediate part(s) to the first part and the second part, the intermediate part(s) being arranged between the first part and the second part in the assembly direction; and
wherein the at least one intermediate part comprises a plurality of intermediate parts, and wherein the pressurized gas containment liner comprises the plurality of intermediate parts, adjacent in an assembly direction.
